(19) United States
(12) Patent Application Publication
(10) Pub. No.: US 2023/0308218 A1
(43) Pub. Date: Sep. 28, 2023

(54) SOFT HYBRID AUTOMATIC REPEAT REQUEST CONFIGURATION

(71) Applicant: QUALCOMM Incorporated, San Diego, CA (US)

(72) Inventors: Konstantinos DIMOU, New York, NY (US); Yi HUANG, San Diego, CA (US); Yan ZHOU, San Diego, CA (US); Xiaoxia ZHANG, San Diego, CA (US); Ahmed ELSHAFIE, San Diego, CA (US); Wei YANG, San Diego, CA (US); Ozcan OZTURK, San Diego, CA (US); Tao LUO, San Diego, CA (US); Peter GAAL, San Diego, CA (US); Jing SUN, San Diego, CA (US)

(21) Appl. No.: 18/002,731

(22) PCT Filed: Aug. 30, 2021
(86) PCT No.: PCT/US2021/071312

§ 371 Date: Dec. 21, 2022

(30) Foreign Application Priority Data
Aug. 31, 2020 (GR) 20200100527

(51) Int. Cl. H04L 1/1812; H04W 72/566; H04W 72/11; H04W 72/1273; H04W 72/232

(52) U.S. Cl. CPC H04L 1/1812; H04W 72/566; H04W 72/11; H04W 72/1273; H04W 72/232

(57) ABSTRACT

Various aspects of the present disclosure generally relate to wireless communication. In some aspects, a user equipment (UE) may receive a downlink communication including a priority indicator indicating that a first priority for a received transmission is to trigger hybrid automatic repeat request (HARQ) feedback of a first type of HARQ feedback or indicating that a second priority for the received transmission is to trigger HARQ feedback of a second type of HARQ feedback, the first type of HARQ feedback including information associated with link adaptation, the information not included in the second type of HARQ feedback. The UE may transmit the HARQ feedback, as a response to the received transmission, based at least in part on receiving the downlink communication and in accordance with whether the first type of HARQ feedback or the second type of HARQ feedback is triggered. Numerous other aspects are provided.

### CROSS-REFERENCE TO RELATED APPLICATION

This Patent Application claims priority to Greece Patent Application No. 20200100527, filed on Aug. 31, 2020, entitled “SOFT HYBRID AUTOMATIC REPEAT REQUEST CONFIGURATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for soft hybrid automatic repeat request configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving a downlink communication including a priority indicator indicating that a first priority for a received transmission is to trigger hybrid automatic repeat request (HARQ) feedback of a first type of HARQ feedback or indicating that a second priority for the received transmission is to trigger HARQ feedback of a second type of HARQ feedback, the first type of HARQ feedback including information associated with link adaptation, the information not included in the second type of HARQ feedback; and transmitting the HARQ feedback, as a response to the received transmission, based at least in part on receiving the downlink communication and in accordance with whether the first type of HARQ feedback or the second type of HARQ feedback is triggered.

In some aspects, a method of wireless communication performed by a base station includes transmitting a downlink communication including a priority indicator indicating that a first priority for a particular transmission is to trigger HARQ feedback of a first type of HARQ feedback or indicating that a second priority for the particular transmission is to trigger HARQ feedback of a second type of HARQ feedback, the first type of HARQ feedback including information associated with link adaptation, the information not included in the second type of HARQ feedback; and receiving the HARQ feedback, as a response to the particular transmission, based at least in part on receiving the downlink communication and in accordance with whether the first type of HARQ feedback or the second type of HARQ feedback is triggered.

In some aspects, a UE for wireless communication includes a memory; and one or more processors operatively coupled to the memory, the memory and the one or more processors configured to: receive a downlink communication including a priority indicator indicating that a first priority for a received transmission is to trigger HARQ feedback of a first type of HARQ feedback or indicating that a second priority for the received transmission is to trigger HARQ feedback of a second type of HARQ feedback, the first type of HARQ feedback including information associated with link adaptation, the information not included in the second type of HARQ feedback; and transmit the HARQ feedback, as a response to the received transmission, based at least in part on receiving the downlink communication and in accordance with whether the first type of HARQ feedback or the second type of HARQ feedback is triggered.

In some aspects, a base station for wireless communication includes a memory; and one or more processors operatively coupled to the memory, the memory and the one or more processors configured to: transmit a downlink communication including a priority indicator indicating that a first priority for a particular transmission is to trigger HARQ feedback of a first type of HARQ feedback or indicating that a second priority for the particular transmission is to trigger HARQ feedback of a second type of HARQ feedback, the first type of HARQ feedback including information associated with link adaptation, the information not included in the second type of HARQ feedback; and receive the HARQ feedback, as a response to the particular transmission, based at least in part on receiving the downlink communication and in accordance with whether the first type of HARQ feedback or the second type of HARQ feedback is triggered.

In some aspects, a non-transitory computer-readable medium storing a set of instructions for wireless communication includes one or more instructions that, when executed by one or more processors of a UE, cause the UE to: receive a downlink communication including a priority indicator indicating that a first priority for a received transmission is to trigger HARQ feedback of a first type of HARQ feedback or indicating that a second priority for the received transmission is to trigger HARQ feedback of a second type of HARQ feedback, the first type of HARQ feedback including information associated with link adaptation, the information not included in the second type of HARQ feedback; and transmit the HARQ feedback, as a response to the received transmission, based at least in part on receiving the downlink communication and in accordance with whether the first type of HARQ feedback or the second type of HARQ feedback is triggered.

In some aspects, a non-transitory computer-readable medium storing a set of instructions for wireless communication includes one or more instructions that, when executed by one or more processors of a base station, cause the base station to: transmit a downlink communication including a priority indicator indicating that a first priority for a particular transmission is to trigger hybrid automatic repeat request (HARQ) feedback of a first type of HARQ feedback or indicating that a second priority for the particular transmission is to trigger HARQ feedback of a second type of HARQ feedback, the first type of HARQ feedback including information associated with link adaptation, the information not included in the second type of HARQ feedback; and receive the HARQ feedback, as a response to the particular transmission, based at least in part on receiving the downlink communication and in accordance with whether the first type of HARQ feedback or the second type of HARQ feedback is triggered.

In some aspects, an apparatus for wireless communication includes means for receiving a downlink communication including a priority indicator indicating that a first priority for a received transmission is to trigger HARQ feedback of a first type of HARQ feedback or indicating that a second priority for the received transmission is to trigger HARQ feedback of a second type of HARQ feedback, the first type of HARQ feedback including information associated with link adaptation, the information not included in the second type of HARQ feedback; and means for transmitting the HARQ feedback, as a response to the received transmission, based at least in part on receiving the downlink communication and in accordance with whether the first type of HARQ feedback or the second type of HARQ feedback is triggered.

In some aspects, an apparatus for wireless communication includes means for transmitting a downlink communication including a priority indicator indicating that a first priority for a particular transmission is to trigger hybrid automatic repeat request (HARQ) feedback of a first type of HARQ feedback or indicating that a second priority for the particular transmission is to trigger HARQ feedback of a second type of HARQ feedback, the first type of HARQ feedback including information associated with link adaptation, the information not included in the second type of HARQ feedback; and means for receiving the HARQ feedback, as a response to the particular transmission, based at least in part on receiving the downlink communication and in accordance with whether the first type of HARQ feedback or the second type of HARQ feedback is triggered.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of abase station in communication with a UE in a wireless network, in accordance with the present disclosure.

FIG. 3 is a diagram illustrating an example associated with soft hybrid automatic repeat request (HARQ) feedback configuration, in accordance with the present disclosure.

FIGS. 4-5 are diagrams illustrating example processes associated with soft HARQ feedback configuration, in accordance with the present disclosure.

FIGS. 6-7 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

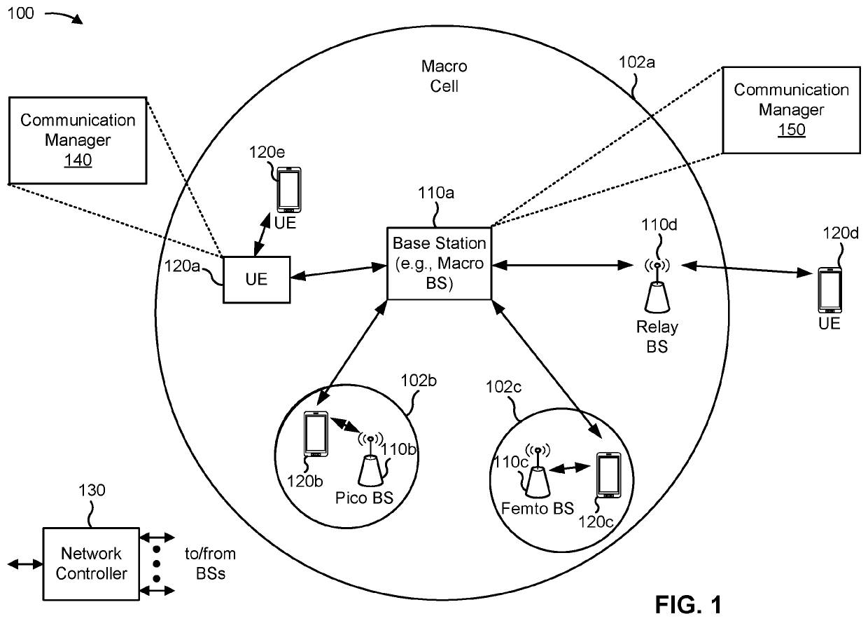

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a base station) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

Abase station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components.

In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a downlink communication including a priority indicator indicating that a first priority for a received transmission is to trigger hybrid automatic repeat request (HARQ) feedback of a first type of HARQ feedback or indicating that a second priority for the received transmission is to trigger HARQ feedback of a second type of HARQ feedback, [0001] the first type of HARQ feedback including information associated with link adaptation, the information not included in the second type of HARQ feedback; and transmit the HARQ feedback, as a response to the received transmission, based at least in part on receiving the downlink communication and in accordance with whether the first type of HARQ feedback or the second type of HARQ feedback is triggered. Additionally, or alternatively, the communication manager 140 may perform one or more other operations described herein.

In some aspects, the base station 110 may include a communication manager 150. As described in more detail elsewhere herein, the communication manager 150 may transmit a downlink communication including a priority indicator indicating that a first priority for a particular transmission is to trigger hybrid automatic repeat request (HARQ) feedback of a first type of HARQ feedback or indicating that a second priority for the particular transmission is to trigger HARQ feedback of a second type of HARQ feedback, [0001] the first type of HARQ feedback including information associated with link adaptation, the information not included in the second type of HARQ feedback; and receive the HARQ feedback, as a response to the particular transmission, based at least in part on receiving the downlink communication and in accordance with whether the first type of HARQ feedback or the second type of HARQ feedback is triggered. Additionally, or alternatively, the communication manager 150 may perform one or more other operations described herein.

As indicated above, FIG. 1 is provided as an example. Other examples may differ from what is described with regard to FIG. 1.

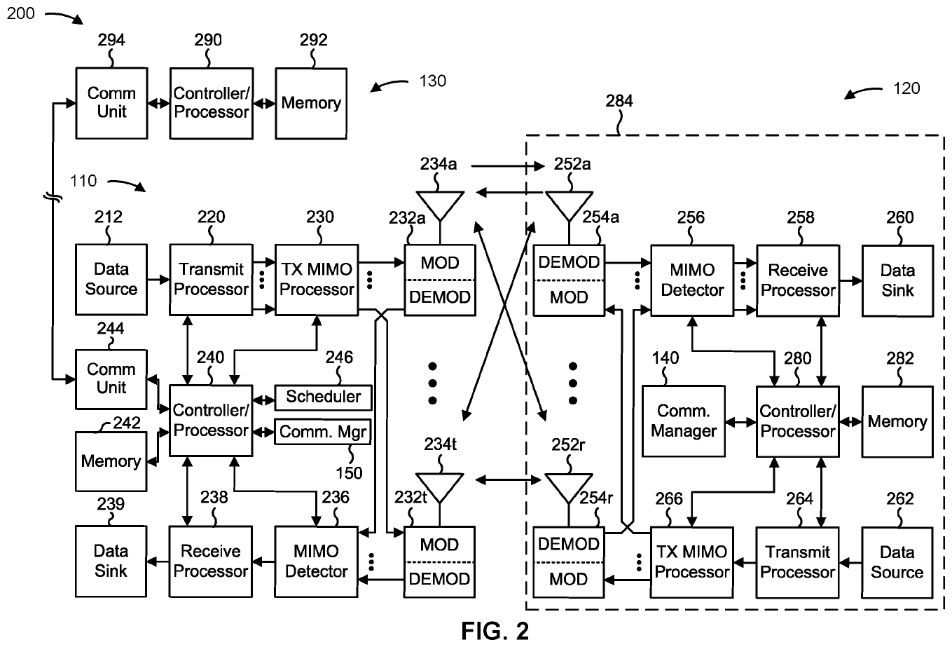

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

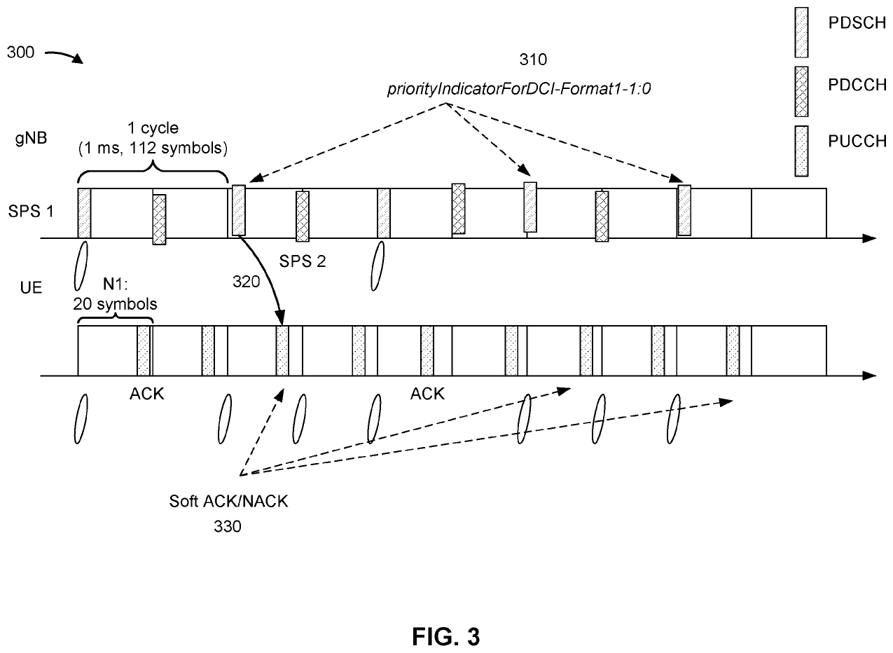

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-7).

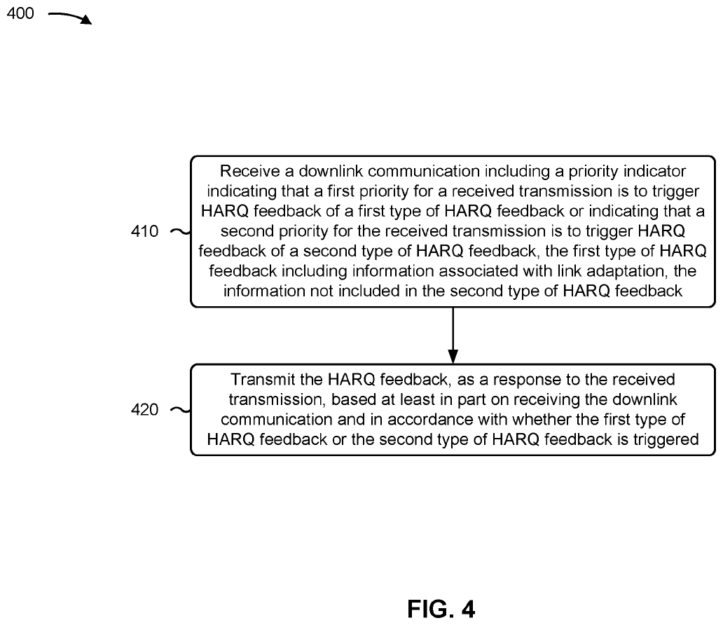

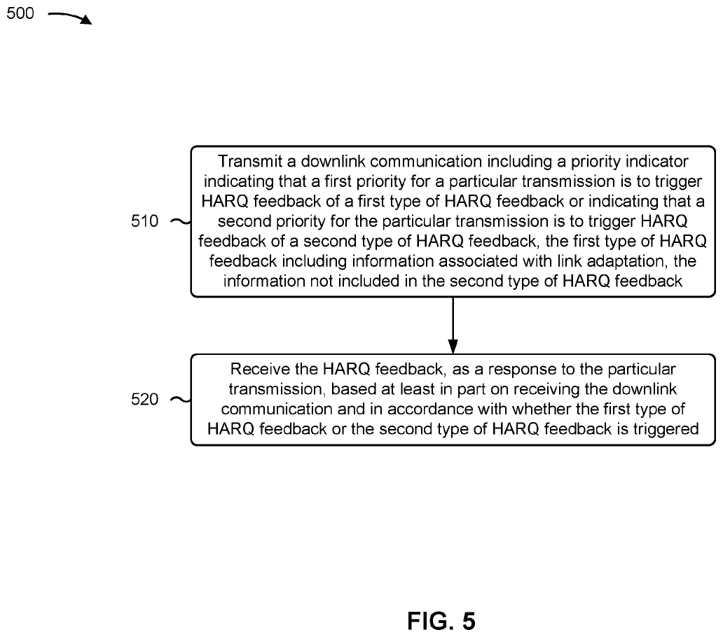

The controller/processor 240 of the base station 110, the controller/processor 280 of the UE 120, and/or any other component(s) of FIG. 2 may perform one or more techniques associated with soft hybrid automatic repeat request (HARQ) feedback configuration, as described in more detail elsewhere herein. For example, the controller/processor 240 of the base station 110, the controller/processor 280 of the UE 120, and/or any other component(s) of FIG. 2 may perform or direct operations of, for example, process 400 of FIG. 4, process 500 of FIG. 5, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 400 of FIG. 4, process 500 of FIG. 5, and/or other processes as described herein. In some examples, executing instructions may include running the instructions, converting the instructions, compiling the instructions, and/or interpreting the instructions, among other examples.

In some aspects, UE 120 may include means for receiving (e.g., using antenna 252, DEMOD 254, MIMO detector 256, receive processor 258, controller/processor 280, memory 282, and/or the like) a downlink communication including a priority indicator indicating that a first priority for a received transmission is to trigger HARQ feedback of a first type of HARQ feedback or indicating that a second priority for the received transmission is to trigger HARQ feedback of a second type of HARQ feedback, the first type of HARQ feedback including information associated with link adaptation, the information not included in the second type of HARQ feedback, means for transmitting (e.g., using controller/processor 280, transmit processor 264, TX MIMO processor 266, MOD 254, antenna 252, memory 282, and/or the like) the HARQ feedback, as a response to the received transmission, based at least in part on receiving the downlink communication and in accordance with whether the first type of HARQ feedback or the second type of HARQ feedback is triggered, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting (e.g., using controller/processor 240, transmit processor 220, TX MIMO processor 230, MOD 232, antenna 234, memory 242, and/or the like) a downlink communication including a priority indicator indicating that a first priority for a particular transmission is to trigger HARQ feedback of a first type of HARQ feedback or indicating that a second priority for the particular transmission is to trigger HARQ feedback of a second type of HARQ feedback, the first type of HARQ feedback including information associated with link adaptation, the information not included in the second type of HARQ feedback, means for receiving (e.g., using antenna 234, DEMOD 232, MIMO detector 236, receive processor 238, controller/processor 240, memory 242, and/or the like) the HARQ feedback, as a response to the particular transmission, based at least in part on receiving the downlink communication and in accordance with whether the first type of HARQ feedback or the second type of HARQ feedback is triggered, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

In some communications systems, a UE and a base station may use HARQ feedback to ensure reliability of wireless communications. For example, a base station may transmit a message, such as a downlink control information, on a downlink, and the UE may transmit HARQ feedback on an uplink to indicate whether the UE was successful in receiving the message (e.g., a HARQ acknowledgement (ACK)) or was unsuccessful in receiving the message (e.g., a HARQ negative acknowledgement (NACK)). In some cases, the base station may transmit messages on a downlink, such as physical downlink shared channel (PDSCH) messages, using semi-persistent scheduling (SPS). To ensure flexibility in terms of a periodicity of transmitting downlink messages, a reliability of transmitting downlink messages, and/or the like, the base station may configure a plurality of different SPS cycles. For example, the base station may configure a first SPS cycle for a first set of downlink messages and a second SPS cycle for a second set of downlink messages. Additionally, or alternatively, UE 120 may use dynamic grant (DG) scheduling for PDSCH messages, or physical downlink control channel (PDCCH) messages, and/or the like.

A UE may be configured to transmit a plurality of types of HARQ feedback messages associated with a plurality of HARQ configurations. For example, the UE may be configured to transmit soft HARQ feedback, which may include an indicator of whether or not a message was successfully received, and may include additional information associated with link adaptation. Such additional information associated with link adaptation can include, for example, a log likelihood ration (LLR) output, a block error ratio (BLER), an indicator of a network characteristic (e.g., a channel quality indicator (CQI), a power offset, a power control parameter, a margin for a minimum required signal to interference and noise ratio (SINR), a modulation and coding scheme (MCS) (e.g., a delta MCS (deltaMCS) parameter identifying a change to an MCS), a preferred link (when in a multi-link communication mode), a reason for a decoding failure (when transmitting a HARQ NACK), and/or the like), and/or the like. This additional information may provide the base station with explicit feedback for link adaptation. The explicit feedback can help the base station arrive at the best parameters (e.g., an optimized set of parameters or a more optimal set of parameters than a previous set of parameters) for the link more quickly than a simple indication of whether the message was successfully received or not. In one example, the base station may use the additional information to set an MCS. Additionally, or alternatively, the UE may be configured to transmit non-soft HARQ feedback (which may sometimes be termed “HARQ feedback”), which may include an indicator of whether a message was successfully received, but may lack the additional information that is present in soft HARQ feedback. The additional information of, for example, soft HARQ feedback may assist the base station in determining link adaptation for a retransmission of a message, a subsequent transmission of another message, and/or the like. However, when the UE is configured to transmit a plurality of types of HARQ feedback, the UE may lack information regarding which type of HARQ feedback the UE is to transmit.

Some aspects described herein enable priority-based HARQ feedback configuration. For example, a base station may include, in downlink control information (DCI), one or more priority indicators for one or more HARQ feedback messages. In other words, when the UE is configured with a plurality of SPS configurations, the UE may receive DCI identifying a priority indicator for each SPS configuration of the plurality of SPS configurations. In this case, when the UE is triggered to transmit a particular HARQ feedback message based at least in part on a received downlink message associated with a particular SPS configuration, of the plurality of SPS configurations, the UE may determine a type of HARQ feedback to transmit for the particular HARQ feedback message based at least in part on a priority of the particular SPS configuration. In this way, the base station and the UE ensure that the UE transmits soft HARQ feedback for higher priority SPS configurations, thereby ensuring that the base station has information that can be used for link adaptation and to ensure reliability of the higher priority SPS configurations.

FIG. 3 is a diagram illustrating an example 300 associated with soft HARQ feedback configuration, in accordance with various aspects of the present disclosure. As shown in FIG. 3, example 300 includes communication between a base station 110 and a UE 120. In some aspects, base station 110 and UE 120 may be included in a wireless network, such as wireless network 100. base station 110 and UE 120 may communicate using a plurality of SPS configurations, such as a first SPS configuration (SPS1) and a second SPS configuration (SPS2), on a wireless access link, which may include an uplink and a downlink.

As shown in FIG. 3, and by reference number 310, UE 120 may receive a downlink communication indicating whether HARQ feedback is to be a first type of HARQ feedback or a second type of HARQ feedback. For example, UE 120 may receive a DCI including one or more priority indicators associated with one or more SPS configurations. In this case, the DCI may indicate, for each priority indicator, whether a HARQ feedback message associated with a corresponding SPS configuration is to be the first type of HARQ feedback (e.g., soft HARQ feedback) or the second type of HARQ feedback (e.g., non-soft HARQ feedback). Additionally, or alternatively, UE 120 may receive information identifying a HARQ codebook type that UE 120 is to use is connection with a priority indicator and an associated HARQ feedback message.

In some aspects, base station 110 may set the indicator based at least in part on information identifying a network characteristic. For example, base station 110 may set the indicator based at least in part on network traffic that is to occur during a particular SPS occasion. Additionally, or alternatively, base station 110 may set the indicator based at least in part on previous HARQ feedback, such that soft HARQ feedback is provided for SPS occasions in an SPS configuration that has previously had HARQ NACKs. Additionally, or alternatively, base station 110 may set the indicator based at least in part on a communication configuration of UE 120, of base station 110, and/or the like.

As further shown in FIG. 3, and by reference numbers 320 and 330, UE 120 may receive a downlink message triggering HARQ feedback and may transmit the HARQ feedback in accordance with the one or more priority indicators. For example, UE 120 may receive a PDSCH associated with SPS1 and a first priority, and may transmit a soft HARQ ACK or a NACK as a response to receiving (or failing to receive) the PDSCH based at least in part on the first priority being configured for soft HARQ feedback by the DCI identifying the one or more priority indicators. Base station 110 may receive the HARQ feedback and, when the HARQ feedback is soft HARQ feedback, base station 110 may use indicators included therein to perform link adaptation and adjust a communication configuration, such as an MCS, a transmit power, etc. to improve communication performance along one or more links.

As indicated above, FIG. 3 is provided as an example. Other examples may differ from what is described with respect to FIG. 3.

FIG. 4 is a diagram illustrating an example process 400 performed, for example, by a user equipment (UE), in accordance with various aspects of the present disclosure. Example process 400 is an example where the UE (e.g., UE 120) performs operations associated with soft HARQ configuration.

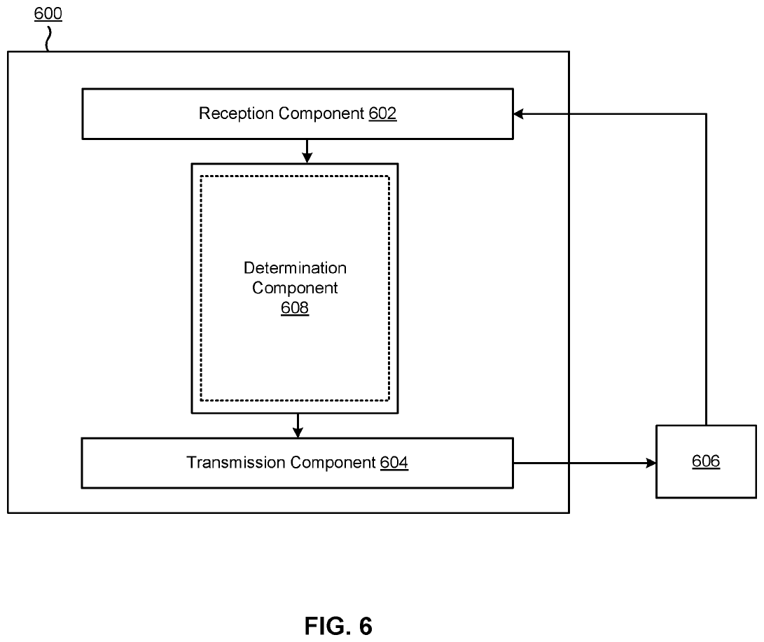

As shown in FIG. 4, in some aspects, process 400 may include receiving a downlink communication including a priority indicator indicating that a first priority for a received transmission is to trigger HARQ feedback of a first type of HARQ feedback or indicating that a second priority for the received transmission is to trigger HARQ feedback of a second type of HARQ feedback, the first type of HARQ feedback including information associated with link adaptation, the information not included in the second type of HARQ feedback (block 410). For example, the UE (e.g., using reception component 602, depicted in FIG. 6) may receive a downlink communication including a priority indicator indicating that a first priority for a received transmission is to trigger HARQ feedback of a first type of HARQ feedback or indicating that a second priority for the received transmission is to trigger HARQ feedback of a second type of HARQ feedback, the first type of HARQ feedback including information associated with link adaptation, the information not included in the second type of HARQ feedback, as described above.

As further shown in FIG. 4, in some aspects, process 400 may include transmitting the HARQ feedback, as a response to the received transmission, based at least in part on receiving the downlink communication and in accordance with whether the first type of HARQ feedback or the second type of HARQ feedback is triggered (block 420). As described elsewhere herein, the priority indicatory can indicate to the UE that the first priority is to trigger the first type of HARQ feedback and the second priority is to trigger the second type of HARQ feedback. As such, the UE can transmit the first type of HARQ feedback when the received transmission has the first priority and can transmit the second type of HARQ feedback when the received transmission has the second priority. For example, the UE (e.g., using transmission component 604, depicted in FIG. 6) may transmit the HARQ feedback, as a response to the received transmission, based at least in part on receiving the downlink communication and in accordance with whether the received transmission has the first priority or the second priority and in accordance with whether the first type of HARQ feedback or the second type of HARQ feedback is triggered, as described above.

Process 400 may include additional aspects, such as any single aspect or any combination of aspects described below and/or in connection with one or more other processes described elsewhere herein.

In a first aspect, the received transmission is a semi-persistent scheduling (SPS) transmission of a physical downlink shared channel (PDSCH).

In a second aspect, alone or in combination with the first aspect, the received transmission is a dynamic grant (DG) physical downlink shared channel (PDSCH) triggering physical uplink control channel (PUCCH) HARQ feedback.

In a third aspect, alone or in combination with one or more of the first and second aspects, the downlink communication is a downlink control information (DCI) communication.

In a fourth aspect, alone or in combination with one or more of the first through third aspects, the first type of HARQ feedback is soft HARQ feedback and the second type of HARQ feedback is non-soft HARQ feedback.

In a fifth aspect, alone or in combination with one or more of the first through fourth aspects, the information associated with link adaptation identifies at least one of a channel quality indicator (CQI), a power offset, a modulation and coding scheme, a power control parameter, an identification of a trigger of a decoding failure.

In a sixth aspect, alone or in combination with one or more of the first through fifth aspects, the HARQ feedback is a HARQ acknowledgement (ACK) or a HARQ negative acknowledgement (NACK).

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a base station, in accordance with various aspects of the present disclosure. Example process 500 is an example where the base station (e.g., base station 110) performs operations associated with soft HARQ configuration.

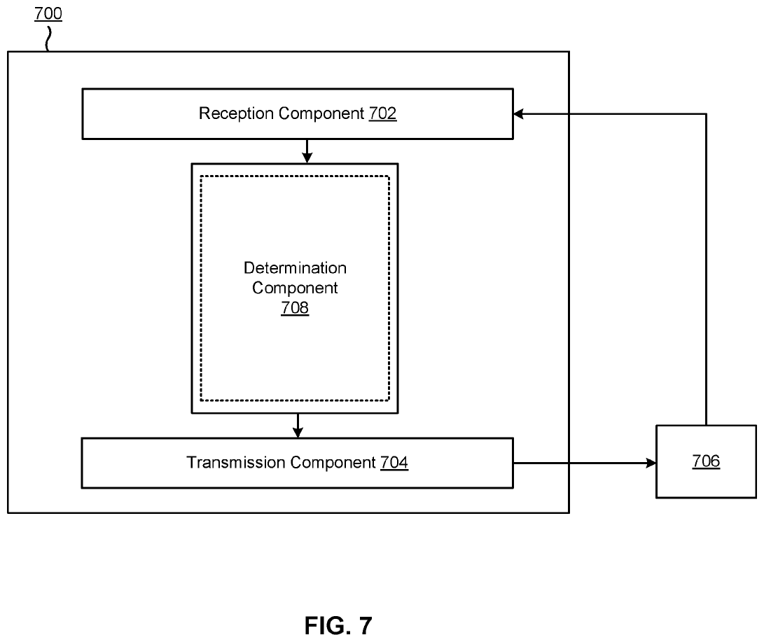

As shown in FIG. 5, in some aspects, process 500 may include transmitting a downlink communication including a priority indicator indicating that a first priority for a particular transmission is to trigger HARQ feedback of a first type of HARQ feedback or indicating that a second priority for the particular transmission is to trigger HARQ feedback of a second type of HARQ feedback, the first type of HARQ feedback including information associated with link adaptation, the information not included in the second type of HARQ feedback (block 510). For example, the base station (e.g., using transmission component 704, depicted in FIG. 7) may transmit a downlink communication including a priority indicator indicating that a first priority for a particular transmission is to trigger HARQ feedback of a first type of HARQ feedback or indicating that a second priority for the particular transmission is to trigger HARQ feedback of a second type of HARQ feedback, the first type of HARQ feedback including information associated with link adaptation, the information not included in the second type of HARQ feedback, as described above.

As further shown in FIG. 5, in some aspects, process 500 may include receiving the HARQ feedback, as a response to the particular transmission, based at least in part on receiving the downlink communication and in accordance with whether the first type of HARQ feedback or the second type of HARQ feedback is triggered (block 520). For example, the base station (e.g., using reception component 702, depicted in FIG. 7) may receive the HARQ feedback, as a response to the particular transmission, based at least in part on receiving the downlink communication and in accordance with whether the first type of HARQ feedback or the second type of HARQ feedback is triggered, as described above.

Process 500 may include additional aspects, such as any single aspect or any combination of aspects described below and/or in connection with one or more other processes described elsewhere herein.

In a first aspect, the particular transmission is a semi-persistent scheduling (SPS) transmission of a physical downlink shared channel (PDSCH).

In a second aspect, alone or in combination with the first aspect, the particular transmission is a dynamic grant (DG) physical downlink shared channel (PDSCH) triggering physical uplink control channel (PUCCH) HARQ feedback.

In a third aspect, alone or in combination with one or more of the first and second aspects, the downlink communication is a downlink control information (DCI) communication.

In a fourth aspect, alone or in combination with one or more of the first through third aspects, the first type of HARQ feedback is soft HARQ feedback and the second type of HARQ feedback is non-soft HARQ feedback.

In a fifth aspect, alone or in combination with one or more of the first through fourth aspects, the information associated with link adaptation identifies at least one of a channel quality indicator (CQI), a power offset, a modulation and coding scheme, a power control parameter, an identification of a trigger of a decoding failure.

In a sixth aspect, alone or in combination with one or more of the first through fifth aspects, the HARQ feedback is a HARQ acknowledgement (ACK) or a HARQ negative acknowledgement (NACK).

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a block diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include a determination component 608 among other examples.

In some aspects, the apparatus 600 may be configured to perform one or more operations described herein in connection with FIG. 3. Additionally or alternatively, the apparatus 600 may be configured to perform one or more processes described herein, such as process 400 of FIG. 4, among other examples. In some aspects, the apparatus 600 and/or one or more components shown in FIG. 6 may include one or more components of the UE described above in connection with FIG. 2. Additionally, or alternatively, one or more components shown in FIG. 6 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the UE described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the UE described above in connection with FIG. 2. In some aspects, the transmission component 604 may be collocated with the reception component 602 in a transceiver.

The reception component 602 may receive a downlink communication including an indicator regarding whether HARQ feedback is a first type of HARQ feedback or a second type of HARQ feedback. The transmission component 604 may transmit the HARQ feedback, as a response to a received transmission, based at least in part on receiving the downlink communication and in accordance with whether the HARQ feedback is indicated to be the first type of HARQ feedback or the second type of HARQ feedback. The determination component 608 may determine a configuration for HARQ feedback and/or determine a type of HARQ feedback to transmit, such as based at least in part on the indicator. In some aspects, the determination component 608 may be a controller or processor.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally or alternatively, a set of (one or more) components shown in FIG. 6 may perform one or more functions described as being performed by another set of components shown in FIG. 6.

FIG. 7 is a block diagram of an example apparatus 700 for wireless communication. The apparatus 700 may be a base station, or a base station may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include one or more of a determination component 708, among other examples.

In some aspects, the apparatus 700 may be configured to perform one or more operations described herein in connection with FIG. 3. Additionally or alternatively, the apparatus 700 may be configured to perform one or more processes described herein, such as process 500 of FIG. 5 or a combination thereof. In some aspects, the apparatus 700 and/or one or more components shown in FIG. 7 may include one or more components of the base station described above in connection with FIG. 2. Additionally, or alternatively, one or more components shown in FIG. 7 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the base station described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the base station described above in connection with FIG. 2. In some aspects, the transmission component 704 may be collocated with the reception component 702 in a transceiver.

The transmission component 704 may transmit a downlink communication including an indicator regarding whether hybrid automatic repeat request (HARQ) feedback is a first type of HARQ feedback or a second type of HARQ feedback. The reception component 702 may receive the HARQ feedback, as a response to a particular transmission, based at least in part on receiving the downlink communication and in accordance with whether the HARQ feedback is indicated to be the first type of HARQ feedback or the second type of HARQ feedback. The determination component 708 may set the indicator based at least in part on a network traffic parameter, previous HARQ feedback, a communication configuration, and/or the like.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: receiving a downlink communication including a priority indicator indicating that a first priority for a received transmission is to trigger hybrid automatic repeat request (HARQ) feedback of a first type of HARQ feedback or indicating that a second priority for the received transmission is to trigger HARQ feedback of a second type of HARQ feedback, [0001] the first type of HARQ feedback including information associated with link adaptation, the information not included in the second type of HARQ feedback; and transmitting the HARQ feedback, as a response to the received transmission, based at least in part on receiving the downlink communication and in accordance with whether the first type of HARQ feedback or the second type of HARQ feedback is triggered.

Aspect 2: The method of Aspect 1, wherein the received transmission is a semi-persistent scheduling (SPS) transmission of a physical downlink shared channel (PDSCH).

Aspect 3: The method of any of Aspects 1 to 2, wherein the received transmission is a dynamic grant (DG) physical downlink shared channel (PDSCH) triggering physical uplink control channel (PUCCH) HARQ feedback.

Aspect 4: The method of any of Aspects 1 to 3, wherein the downlink communication is a downlink control information (DCI) communication.

Aspect 5: The method of any of Aspects 1 to 4, wherein the first type of HARQ feedback is soft HARQ feedback and the second type of HARQ feedback is non-soft HARQ feedback.

Aspect 6: The method of any of Aspects 1 to 5, wherein the information associated with link adaptation identifies at least one of: a channel quality indicator (CQI), a power offset, a modulation and coding scheme, a power control parameter, a signal to interference and noise ratio parameter, a link preference parameter, or an identification of a trigger of a decoding failure.

Aspect 7: The method of any of Aspects 1 to 6, wherein the HARQ feedback is a HARQ acknowledgement (ACK) or a HARQ negative acknowledgement (NACK).

Aspect 8: A method of wireless communication performed by abase station, comprising: transmitting a downlink communication including a priority indicator indicating that a first priority for a particular transmission is to trigger hybrid automatic repeat request (HARQ) feedback of a first type of HARQ feedback or indicating that a second priority for the particular transmission is to trigger HARQ feedback of a second type of HARQ feedback, [0001] the first type of HARQ feedback including information associated with link adaptation, the information not included in the second type of HARQ feedback; and receiving the HARQ feedback, as a response to the particular transmission, based at least in part on receiving the downlink communication and in accordance with whether the first type of HARQ feedback or the second type of HARQ feedback is triggered.

Aspect 9: The method of Aspect 8, wherein the particular transmission is a semi-persistent scheduling (SPS) transmission of a physical downlink shared channel (PDSCH).

Aspect 10: The method of any of Aspects 8 to 9, wherein the particular transmission is a dynamic grant (DG) physical downlink shared channel (PDSCH) triggering physical uplink control channel (PUCCH) HARQ feedback.

Aspect 11: The method of any of Aspects 8 to 10, wherein the downlink communication is a downlink control information (DCI) communication.

Aspect 12: The method of any of Aspects 8 to 11, wherein the first type of HARQ feedback is soft HARQ feedback and the second type of HARQ feedback is non-soft HARQ feedback.

Aspect 13: The method of any of Aspects 8 to 12, wherein the information associated with link adaptation identifies at least one of: a channel quality indicator (CQI), a power offset, a modulation and coding scheme, a power control parameter, a signal to interference and noise ratio parameter, a link preference parameter, or an identification of a trigger of a decoding failure.

Aspect 14: The method of any of Aspects 8 to 13, wherein the HARQ feedback is a HARQ acknowledgement (ACK) or a HARQ negative acknowledgement (NACK).

Aspect 15: An apparatus for wireless communication at a device, comprising a processor, memory coupled with the processor, and instructions stored in the memory and executable by the processor to cause the apparatus to perform the method of one or more of Aspects 1-7.

Aspect 16: A device for wireless communication, comprising a memory and one or more processors coupled to the memory, the one or more processors configured to perform the method of one or more of Aspects 1-7.

Aspect 17: An apparatus for wireless communication, comprising at least one means for performing the method of one or more of Aspects 1-7.

Aspect 18: A non-transitory computer-readable medium storing code for wireless communication, the code comprising instructions executable by a processor to perform the method of one or more of Aspects 1-7.

Aspect 19: A non-transitory computer-readable medium storing a set of instructions for wireless communication, the set of instructions comprising one or more instructions that, when executed by one or more processors of a device, cause the device to perform the method of one or more of Aspects 1-7.

Aspect 20: An apparatus for wireless communication at a device, comprising a processor, memory coupled with the processor, and instructions stored in the memory and executable by the processor to cause the apparatus to perform the method of one or more of Aspects 8-14.

Aspect 21: A device for wireless communication, comprising a memory and one or more processors coupled to the memory, the one or more processors configured to perform the method of one or more of Aspects 8-14.

Aspect 22: An apparatus for wireless communication, comprising at least one means for performing the method of one or more of Aspects 8-14.

Aspect 23: A non-transitory computer-readable medium storing code for wireless communication, the code comprising instructions executable by a processor to perform the method of one or more of Aspects 8-14.

Aspect 24: A non-transitory computer-readable medium storing a set of instructions for wireless communication, the set of instructions comprising one or more instructions that, when executed by one or more processors of a device, cause the device to perform the method of one or more of Aspects 8-14.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a downlink communication including a priority indicator indicating that a first priority for a received transmission is to trigger hybrid automatic repeat request (HARQ) feedback of a first type of HARQ feedback or indicating that a second priority for the received transmission is to trigger HARQ feedback of a second type of HARQ feedback, the first type of HARQ feedback including information associated with link adaptation, the information not included in the second type of HARQ feedback; and
transmitting the HARQ feedback, as a response to the received transmission, based at least in part on receiving the downlink communication and in accordance with whether the first type of HARQ feedback or the second type of HARQ feedback is triggered.

2. The method of claim 1, wherein the received transmission is a semi-persistent scheduling (SPS) transmission of a physical downlink shared channel (PDSCH).

3. The method of claim 1, wherein the received transmission is a dynamic grant (DG) physical downlink shared channel (PDSCH) triggering physical uplink control channel (PUCCH) HARQ feedback.

4. The method of claim 1, wherein the downlink communication is a downlink control information (DCI) communication.

5. The method of claim 1, wherein the first type of HARQ feedback is soft HARQ feedback and the second type of HARQ feedback is non-soft HARQ feedback.

6. The method of claim 1, wherein the information identifies at least one of:
a channel quality indicator (CQI),
a power offset,
a modulation and coding scheme,
a power control parameter,
a signal to interference and noise ratio parameter,
a link preference parameter, or
an identification of a trigger of a decoding failure.

7. The method of claim 1, wherein the HARQ feedback is a HARQ acknowledgement (ACK) or a HARQ negative acknowledgement (NACK).

8. A method of wireless communication performed by a base station, comprising:
transmitting a downlink communication including a priority indicator indicating that a first priority for a particular transmission is to trigger hybrid automatic repeat request (HARQ) feedback of a first type of HARQ feedback or indicating that a second priority for the particular transmission is to trigger HARQ feedback of a second type of HARQ feedback, the first type of HARQ feedback including information associated with link adaptation, the information not included in the second type of HARQ feedback; and
receiving the HARQ feedback, as a response to the particular transmission, based at least in part on receiving the downlink communication and in accordance with whether the first type of HARQ feedback or the second type of HARQ feedback is triggered.

9. The method of claim 8, wherein the particular transmission is a semi-persistent scheduling (SPS) transmission of a physical downlink shared channel (PDSCH).

10. The method of claim 8, wherein the particular transmission is a dynamic grant (DG) physical downlink shared channel (PDSCH) triggering physical uplink control channel (PUCCH) HARQ feedback.

11. The method of claim 8, wherein the downlink communication is a downlink control information (DCI) communication.

12. The method of claim 8, wherein the first type of HARQ feedback is soft HARQ feedback and the second type of HARQ feedback is non-soft HARQ feedback.

13. The method of claim 8, wherein the information associated with link adaptation identifies at least one of:
a channel quality indicator (CQI),
a power offset,
a modulation and coding scheme,
a power control parameter,
a signal to interference and noise ratio parameter,
a link preference parameter, or
an identification of a trigger of a decoding failure.

14. The method of claim 8, wherein the HARQ feedback is a HARQ acknowledgement (ACK) or a HARQ negative acknowledgement (NACK).

15. A user equipment (UE) for wireless communication, comprising:
a memory; and
one or more processors, coupled to the memory, configured to:
receive a downlink communication including a priority indicator indicating that a first priority for a received transmission is to trigger hybrid automatic repeat request (HARQ) feedback of a first type of HARQ feedback or indicating that a second priority for the received transmission is to trigger HARQ feedback of a second type of HARQ feedback, the first type of HARQ feedback including information associated with link adaptation, the information not included in the second type of HARQ feedback; and
transmit the HARQ feedback, as a response to the received transmission, based at least in part on receiving the downlink communication and in accordance with whether the first type of HARQ feedback or the second type of HARQ feedback is triggered.

16. The UE of claim 15, wherein the received transmission is a semi-persistent scheduling (SPS) transmission of a physical downlink shared channel (PDSCH).

17. The UE of claim 15, wherein the received transmission is a dynamic grant (DG) physical downlink shared channel (PDSCH) triggering physical uplink control channel (PUCCH) HARQ feedback.

18. The UE of claim 15, wherein the downlink communication is a downlink control information (DCI) communication.

19. The UE of claim 15, wherein the first type of HARQ feedback is soft HARQ feedback and the second type of HARQ feedback is non-soft HARQ feedback.

20. The UE of claim 15, wherein the information associated with link adaptation identifies at least one of:
a channel quality indicator (CQI),
a power offset,
a modulation and coding scheme,
a power control parameter,
a signal to interference and noise ratio parameter,
a link preference parameter, or
an identification of a trigger of a decoding failure.

21. The UE of claim 15, wherein the HARQ feedback is a HARQ acknowledgement (ACK) or a HARQ negative acknowledgement (NACK).

22. A base station for wireless communication, comprising:
a memory; and
one or more processors, coupled to the memory, configured to:
transmit a downlink communication including a priority indicator indicating that a first priority for a particular transmission is to trigger hybrid automatic repeat request (HARQ) feedback of a first type of HARQ feedback or indicating that a second priority for the particular transmission is to trigger HARQ feedback of a second type of HARQ feedback, the first type of HARQ feedback including information associated with link adaptation, the information not included in the second type of HARQ feedback; and
receive the HARQ feedback, as a response to the particular transmission, based at least in part on receiving the downlink communication and in accordance with whether the first type of HARQ feedback or the second type of HARQ feedback is triggered.

23. The base station of claim 22, wherein the particular transmission is a semi-persistent scheduling (SPS) transmission of a physical downlink shared channel (PDSCH).

24. The base station of claim 22, wherein the particular transmission is a dynamic grant (DG) physical downlink shared channel (PDSCH) triggering physical uplink control channel (PUCCH) HARQ feedback.

25. The base station of claim 22, wherein the downlink communication is a downlink control information (DCI) communication.

26. The base station of claim 22, wherein the first type of HARQ feedback is soft HARQ feedback and the second type of HARQ feedback is non-soft HARQ feedback.

27. The base station of claim 22, wherein the information associated with link adaptation identifies at least one of:
a channel quality indicator (CQI),
a power offset,
a modulation and coding scheme,
a power control parameter,
a signal to interference and noise ratio parameter,
a link preference parameter, or
an identification of a trigger of a decoding failure.

28. The base station of claim 22, wherein the HARQ feedback is a HARQ acknowledgement (ACK) or a HARQ negative acknowledgement (NACK).
